(19) United States
(12) Patent Application Publication
(10) Pub. No.: US 2024/0256582 A1
(43) Pub. Date: Aug. 1, 2024

(54) Search with Generative Artificial Intelligence

(71) Applicant: Glean Technologies, Inc., Palo Alto, CA (US)

(72) Inventors: Arvind Jain, Los Altos, CA (US); Calvin Qi, San Francisco, CA (US); Chau Hai Tran, New York, NY (US); Eddie Zhou, Redwood City, CA (US); Megha Jhunjhunwala, Redwood City, CA (US); Mrinal Mohit, San Francisco, CA (US); Pancham Yadav, San Francisco, CA (US); Philip Ophus, Redwood City, CA (US); Shivaal Roy, Palo Alto, CA (US); Vivek Choksi, Los Altos Hills, CA (US)

(73) Assignee: Glean Technologies, Inc., Palo Alto, CA (US)

(21) Appl. No.: 18/330,999

(22) Filed: Jun. 7, 2023

Related U.S. Application Data
(60) Provisional application No. 63/482,040, filed on Jan. 28, 2023.

(51) Int. Cl. G06F 16/332; G06F 16/338; G06N 20/00

(52) U.S. Cl. CPC G06F 16/3329; G06F 16/338; G06N 20/00

(57) ABSTRACT

Methods and apparatuses for utilizing generative artificial intelligence (AI) techniques to automatically generate and display summaries of search results are described. A search and knowledge management system may generate a set of search results for a given search query and provide the set of search results (e.g., a set of verified documents that are the most relevant verified documents for the search query) as part of an input prompt to guide a generative AI model in generating a summary response of the set of search results. The generative AI model may comprise a Generative Pre-trained Transformer (GPT) model. The summary response may comprise a natural language text response and the set of search results may comprise electronic documents and messages and/or portions thereof.

### CLAIM OF PRIORITY

This application claims the benefit of and priority to U.S. Provisional Application No. 63/482,040, filed Jan. 28, 2023, which is herein incorporated by reference in its entirety.

### BACKGROUND

Individuals associated with an organization (e.g., a company or business entity) may have restricted access to electronic documents and data that are stored across various repositories and data stores, such as enterprise databases and cloud-based data storage services. The data may comprise unstructured data or structured data (e.g., the data may be stored within a relational database). A search engine may allow the data to be indexed, searched, and displayed to authorized users that have permission to access or view the data. A user of the search engine may provide a textual search query to the search engine and in return the search engine may display the most relevant search results for the search query as links to electronic documents, web pages, electronic messages, images, videos, and other digital content. To determine the most relevant search results, the search engine may search for relevant information within a search index for the data and then score and rank the relevant information. In some cases, an electronic document indexed by the search engine may have an associated access control list (ACL) that includes access control entries that identify the access rights that the user has to the electronic document. The most relevant search results for the search query that are displayed to the user may comprise links to electronic documents and other digital content that the user is authorized to access in accordance with access control lists for the underlying electronic documents and other digital content.

### BRIEF SUMMARY

Systems and methods for applying generative artificial intelligence (AI) techniques to automatically generate and display summaries of search results are provided. In some cases, a search engine or search system that leverages a generative AI model may generate a set of search results for a given search query and provide the set of search results as part of an input prompt to the generative AI model to generate a summary response of the set of search results. The generative AI model may comprise a Generative Pre-trained Transformer (GPT) model or other generative AI model. The summary response may comprise, for example, a natural language text response. The set of search results may comprise text from electronic documents and messages and/or portions thereof.

According to some embodiments, the technical benefits of the systems and methods disclosed herein include reduced energy consumption and cost of computing resources, reduced search system downtime, increased quality of search results, increased reliability of information provided to search users, and improved search system performance.

### BRIEF DESCRIPTION OF THE SEVERAL VIEWS OF THE DRAWINGS

Like-numbered elements may refer to common components in the different figures.

FIG. 1 depicts one embodiment of a networked computing environment.

FIG. 2A depicts one embodiment of a search and knowledge management system.

FIGS. 2B-2D depicts various embodiments of a search and knowledge management system.

FIGS. 3A-3G depict various embodiments of a mobile device providing a user interface for interacting with a permissions-aware search and knowledge management system.

FIG. 4A depicts a flowchart describing one embodiment of a process for generating and displaying a summary of search results for a given search query.

FIG. 4B depicts a flowchart describing one embodiment of a process for generating a summary of search results for a given search query and storing the summary as a canonical summary.

FIG. 4C depicts a flowchart describing one embodiment of a process for generating a summary of search results for a given search query and storing the summary.

### DETAILED DESCRIPTION

Technology described herein intelligently utilizes large language models and generative artificial intelligence (AI) to improve the quality and relevance of search results and to improve the responses provided by automated question answering systems. A search and knowledge management system may leverage generative AI techniques to automatically generate and display a response (e.g., an answer) to a search query (e.g., submitted via a search bar) or in response to an implied search query based on end user activity within a persistent chat channel or within an electronic document (e.g., the end user activity may comprise detecting that an end user has modified a particular portion of the electronic document). In some embodiments, the search and knowledge management system may perform automated question answering on-SERP (on a search engine results page) or within an application, such as a word processing application or a communications application (e.g., an instant messaging or chat application). The search and knowledge management system may automatically generate and display text summaries for portions of a document as an end user is modifying or scrolling through portions of the document (e.g., upon detection that the end user has updated a line of source code or a sentence within a word processing document). The search and knowledge management system may automatically generate textual summaries for electronic messages (e.g., email messages) that have not yet been read or viewed by the end user on a periodic basis or upon detection that the end user has opened a particular application.

Generative AI may refer to unsupervised and/or semi-supervised machine learning algorithms that may be used to generate new content, such as newly generated text, code, images, and videos. Machine learning models for generating new content may include Generative Adversarial Network (GAN) models and Generative Pre-trained Transformer (GPT) models. A GAN model typically includes two adversarial (or competing) networks comprising a generator network and a discriminator network. Over time, both the generator network and the discriminator network may be trained such that the generator network learns to generate a more plausible output and the discriminator network learns to distinguish the output of the generator network from real data (or ground truth data).

A GPT model may comprise a type of large language model (LLM) that uses deep learning to generate human-like text. A GPT model may be referred to as being “generative” because it can generate new content based on a given input prompt (e.g., a text prompt), “pre-trained” because it is trained on a large corpus of data (e.g., text data) before being fine-tuned for specific tasks, and a “transformer” because it utilizes a transformer-based neural network architecture to process the input prompt to generate the output content (or response). A transformer model may include an encoder and decoder. In some cases, the encoder and decoder may comprise one or more encoding and/or decoding layers. Each encoding and decoding layer may include a self-attention mechanism that relates tokens within a series of tokens to other tokens within the series. In one example, the self-attention mechanism may allow the transformer model to examine a word within a sentence and determine the relative importance of other words within the same sentence to the examined word.

In some embodiments, a machine learning model may be trained to generate a natural language text response (or completion) given an inputted text prompt. Ideally, the text prompt should provide clear and sufficient information to help guide the machine learning model to generate an appropriate text response. Prompt engineering may be used to alter or update the text prompt such that the machine learning model generates a more relevant text response. In some cases, the text response may be generated by predicting the next set of words in a sequence of words provided by the text prompt using a transformer model, such as a GPT (Generative Pre-trained Transformer) language model. The transformer model may be trained using a sets of input prompt-response pairs.

A technical issue with using generative AI to generate a response (e.g., predicted text) for a given prompt (e.g., inputted text) is that the generated response may not provide a truthful or relevant answer for the inputted prompt. In some embodiments, a search and knowledge management system may provide a set of search results (e.g., a set of verified documents) to guide a machine learning model in generating a response (e.g., a natural language text response). The technical benefits of providing a set of search results (e.g., comprising reference documents that have been verified by document owners) with the prompt and/or requesting that the generated response include citations or references to the particular search results of the set of search results used for generating the response is that the integrity of the generated response may be improved.

In some embodiments, a search and knowledge management system may be used to identify the top ten documents for a particular search query and the inputted prompt to a machine learning model (e.g., a generative AI model) may include the top ten documents along with a text directive to reference a subset of the top ten documents that were used to generate the response. In some cases, only verified reference documents may be included with the inputted prompt used for generating the response. Thereafter, the generated response and/or the particular search results referenced by the response may be verified for truthfulness prior to displaying the response. A second machine learning model may be used to confirm that the generated response provides a truthful or factual answer for the inputted prompt.

In some embodiments, the number of reference documents passed to a generative AI model or included with the inputted prompt may vary based on an estimated latency for generating the response. In one example, if the estimated latency for returning or displaying a generated response is greater than a threshold latency (e.g., the latency is estimated to be greater than one second), then the number of reference documents may be reduced or limited to at most five reference documents; otherwise, if the estimated latency for returning or displaying the generated response is not greater than the threshold latency, then the number of reference documents may be increased or limited to at most fifty reference documents. The number of reference documents included with an inputted prompt may be set based on the threshold latency or set such that the estimated latency for returning or displaying the generated response is equal to the threshold latency. In one example, the number of reference documents may be set such that the estimated latency for returning or displaying the generated response is equal to one second.

In some embodiments, the total amount of text (or the combined snippet sizes for a set of reference documents) associated with a set of reference documents passed to a generative AI model or included with the inputted prompt may vary based on an estimated latency for generating the response. In one example, if the estimated latency for returning or displaying a generated response is less than a threshold latency (e.g., the estimated latency for displaying a suggested answer to a question asked within a persistent chat channel is less than three seconds), then the total amount of text may be increased or set to at most 5000 words per reference document; otherwise, if the estimated latency for returning or displaying the generated response is greater than the threshold latency, then the total amount of text per reference document may be reduced or set to at most 1000 words. In some cases, the portions of text within a reference document that are provided to a generative AI model may be determined using a search engine that determines the most relevant set of sentences within the reference document that do not exceed a threshold number of words per reference document.

In some embodiments, as the time to generate a response using a generative AI model may exceed a threshold latency (e.g., the response may take more than two seconds to generate), the response (e.g., a summary of search results) may be generated in the background and stored in a frequently asked questions (FAQ) database while the search results themselves are displayed in near real time. In some cases, the response may be generated in the background and stored in the FAQ database in response to detection that at least a threshold number of end users have asked a semantically similar question or the semantically similar question has been asked at least a threshold number of times (e.g., at least two times by the same end user or different end users). In some cases, a search and knowledge management system may generate a set of search results for a search query and immediately display the set of search results while a summary of the set of search results is generated in the background and then displayed upon completion of the summary being generated or may be stored in a database for future retrieval.

In some embodiments, a search and knowledge management system may not utilize generative AI when a search query is submitted until it detects a triggering condition, such as that a threshold number of end users have asked a semantically similar question or that the semantically similar question has been asked a threshold number of times. Upon detection of the triggering condition, a “simulated” search for the search query may be performed using “generic” user permissions set based on the user permissions of the end users that asked the semantically similar question (e.g., the user permissions may be set as the most restrictive permissions out of the end users). The set of search results generated may be provided with a prompt to a generative AI model in order to generate a summary of the set of search results and the resulting summary may be stored in a database such that it may be retrieved quickly the next time an end user asks the same semantically similar question.

In some cases, when generating the summary of the set of search results, the number of reference documents passed to a generative AI model or included with the inputted prompt may be limited to a first number of documents (e.g., at most ten documents) in order to meet a required latency, and then in the background a second number of documents (e.g., at least 100 documents) greater than the first number of documents may be passed to the generative AI model or included with a second inputted prompt in order to generate a more comprehensive summary that is then stored within a database for future retrieval. The technical benefits of immediately displaying search results and then generating a more comprehensive summary of the search results in the background using a generative AI model include improved user experience and reduced latency when retrieving the more comprehensive summary of the search results during subsequent searches that involve the search results. Moreover, generating and storing comprehensive summaries of the search results for frequently asked questions leads to more efficient use of computer and memory resources as fewer searches may be required by users of a search system in order to locate and understand information.

A permissions-aware search and knowledge management system may enable digital content (or content) stored across a variety of local and cloud-based data stores to be indexed, searched, and displayed to authorized users. The searchable content may comprise data or text embedded within electronic documents, hypertext documents, text documents, web pages, electronic messages, instant messages, database fields, digital images, and wikis. An enterprise or organization may restrict access to the digital content over time by dynamically restricting access to different sets of data to different groups of people using access control lists (ACLs) or authorization lists that specify which users or groups of users of the permissions-aware search and knowledge management system may access, view, or alter particular sets of data. A user of the permissions-aware search and knowledge management system may be identified via a unique username or a unique alphanumeric identifier. In some cases, an email address or a hash of the email address for the user may be used as the primary identifier for the user. To determine whether a user executing a search query has sufficient access rights to view particular search results, the permissions-aware search and knowledge management system may determine the access rights via ACLs for sets of data (e.g., for multiple electronic documents) underlying the particular search results at the time that the search is executed by the user or prior to the display of the particular search results to the user (e.g., the access rights may have been set when the sets of data underlying the particular search results were indexed).

To determine the most relevant search results for the user's search query, the permissions-aware search and knowledge management system may identify a number of relevant documents within a search index for the searchable content that satisfy the user's search query. The relevant documents (or items) may then be ranked by determining an ordering of the relevant documents from the most relevant document to the least relevant document. A document may comprise any piece of digital content that can be indexed, such as an electronic message or a hypertext document. A variety of different ranking signals or ranking factors may be used to rank the relevant documents for the user's search query. In some embodiments, the identification and ranking of the relevant documents for the user's search query may take into account user suggested results from the user and/or other users (e.g., from co-workers within the same group as the user or co-located at the same level within a management hierarchy), the amount of time that has elapsed since a user suggested result was established, whether the underlying content was verified by a content owner of the content as being up-to-date or approved content, the amount of time that has elapsed since the underlying content was verified by the content owner, and the recent activity of the user and/or related group members (e.g., a co-worker within the same group as the user recently discussed a particular subject related to the executed search query within a messaging application within the past week).

In some embodiments, the permissions-aware search and knowledge management system may allow a user to search for content and resources across different workplace applications and data sources that are authorized to be viewed by the user. The permissions-aware search and knowledge management system may include a data ingestion and indexing path that periodically acquires content and identity information from different data sources and then adds them to a search index. The data sources may include databases, file systems, document management systems, cloud-based file synchronization and storage services, cloud-based applications, electronic messaging applications, and workplace collaboration applications. In some cases, data updates and new content may be pushed to the data ingestion and indexing path. In other cases, the data ingestion and indexing path may utilize a site crawler or periodically poll the data sources for new, updated, and deleted content. As the content from different data sources may contain different data formats and document types, incoming documents may be converted to plain text or to a normalized data format. The search index may include portions of text, text summaries, unique words, terms, and term frequency information per indexed document. In some cases, the text summaries may only be provided for documents that are frequently searched or accessed. A text summary may include the most relevant sentences, key words, personal names, and locations that are extracted from a document using natural language processing (NLP). The permissions-aware search and knowledge management system may utilize NLP and deep-learning models in order to identify semantic meaning within documents and search queries.

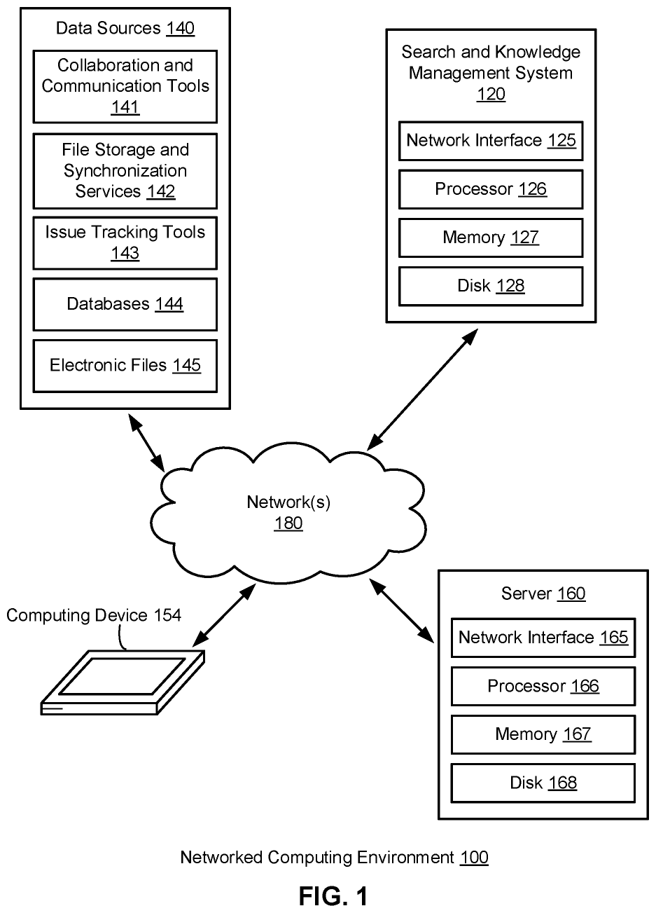

FIG. 1 depicts one embodiment of a networked computing environment 100 in which the disclosed technology may be practiced. The networked computing environment 100 includes a search and knowledge management system 120, one or more data sources 140, server 160, and a computing device 154 in communication with each other via one or more networks 180. The networked computing environment 100 may include a plurality of computing devices interconnected through one or more networks 180. The networked computing environment 100 may correspond with or provide access to a cloud computing environment providing Software-as-a-Service (SaaS) or Infrastructure-as-a-Service (IaaS) services. The one or more networks 180 may allow computing devices and/or storage devices to connect to and communicate with other computing devices and/or other storage devices. In some cases, the networked computing environment 100 may include other computing devices and/or other storage devices not shown. The other computing devices may include, for example, a mobile computing device, a non-mobile computing device, a server, a workstation, a laptop computer, a tablet computer, a desktop computer, or an information processing system. The other storage devices may include, for example, a storage area network storage device, a networked-attached storage device, a hard disk drive, a solid-state drive, a data storage system, or a cloud-based data storage system. The one or more networks 180 may include a cellular network, a mobile network, a wireless network, a wired network, a secure network such as an enterprise private network, an unsecure network such as a wireless open network, a local area network (LAN), a wide area network (WAN), the Internet, or a combination of networks.

In some embodiments, the computing devices within the networked computing environment 100 may comprise real hardware computing devices or virtual computing devices, such as one or more virtual machines. The storage devices within the networked computing environment 100 may comprise real hardware storage devices or virtual storage devices, such as one or more virtual disks. The read hardware storage devices may include non-volatile and volatile storage devices.

The search and knowledge management system 120 may comprise a permissions-aware search and knowledge management system that utilizes user suggested results, document verification, and user activity tracking to generate or rank search results. The search and knowledge management system 120 may enable content stored in storage devices throughout the networked computing environment 100 to be indexed, searched, and displayed to authorized users. The search and knowledge management system 120 may index content stored on various computing and storage devices, such as data sources 140 and server 160, and allow a computing device, such as computing device 154, to input or submit a search query for the content and receive authorized search results with links or references to portions of the content. As the search query is being typed or entered into a search bar on the computing device, potential additional search terms may be displayed to help guide a user of the computing device to enter a more refined search query. This autocomplete assistance may display potential word completions and potential phrase completions within the search bar.

As depicted in FIG. 1, the search and knowledge management system 120 includes a network interface 125, processor 126, memory 127, and disk 128 all in communication with each other. The network interface 125, processor 126, memory 127, and disk 128 may comprise real components or virtualized components. In one example, the network interface 125, processor 126, memory 127, and disk 128 may be provided by a virtualized infrastructure or a cloud-based infrastructure. Network interface 125 allows the search and knowledge management system 120 to connect to one or more networks 180. Network interface 125 may include a wireless network interface and/or a wired network interface. Processor 126 allows the search and knowledge management system 120 to execute computer readable instructions stored in memory 127 in order to perform processes described herein. Processor 126 may include one or more processing units, such as one or more CPUs and/or one or more GPUs. Memory 127 may comprise one or more types of memory (e.g., RAM, SRAM, DRAM, EEPROM, Flash, etc.). Disk 128 may include a hard disk drive and/or a solid-state drive. Memory 127 and disk 128 may comprise hardware storage devices.

In one embodiment, the search and knowledge management system 120 may include one or more hardware processors and/or one or more control circuits for performing a permissions-aware search in which a ranking of search results is outputted or displayed in response to a search query. The search results may be displayed using snippets or summaries of the content. In some embodiments, the search and knowledge management system 120 may be implemented using a cloud-based computing platform or cloud-based computing and data storage services.

The data sources 140 include collaboration and communication tools 141, file storage and synchronization services 142, issue tracking tools 143, databases 144, and electronic files 145. The data sources 140 may include a communication platform not depicted that provides online chat, threaded conversations, videoconferencing, file storage, and application integration. The data sources 140 may comprise software and/or hardware used by an organization to store its data. The data sources 140 may store content that is directly searchable, such as text within text files, word processing documents, presentation slides, and spreadsheets. For audio files or audiovisual content, the audio portion may be converted to searchable text using an audio to text converter or transcription application. For image files and videos, text within the images may be identified and extracted to provide searchable text. The collaboration and communication tools 141 may include applications and services for enabling communication between group members and managing group activities, such as electronic messaging applications, electronic calendars, and wikis or hypertext publications that may be collaboratively edited and managed by the group members. The electronic messaging applications may provide persistent chat channels that are organized by topics or groups. The collaboration and communication tools 141 may also include distributed version control and source code management tools. The file storage and synchronization services 142 may allow users to store files locally or in the cloud and synchronize or share the files across multiple devices and platforms. The issue tracking tools 143 may include applications for tracking and coordinating product issues, bugs, and feature requests. The databases 144 may include distributed databases, relational databases, and NoSQL databases. The electronic files 145 may comprise text files, audio files, image files, video files, database files, electronic message files, executable files, source code files, spreadsheet files, and electronic documents that allow text and images to be displayed consistently independent of application software or hardware.

The computing device 154 may comprise a mobile computing device, such as a tablet computer, that allows a user to access a graphical user interface for the search and knowledge management system 120. A search interface may be provided by the search and knowledge management system 120 to search content within the data sources 140. A search application identifier may be included with every search to preserve contextual information associated with each search. The contextual information may include the data sources and search rankings that were used for the search using the search interface.

A server, such as server 160, may allow a client device, such as the computing device 154, to download information or files (e.g., executable, text, application, audio, image, or video files) from the server or to enable a search query related to particular information stored on the server to be performed. The search results may be provided to the client device by a search engine or a search system, such as the search and knowledge management system 120. The server 160 may comprise a hardware server. In some cases, the server may act as an application server or a file server. In general, a server may refer to a hardware device that acts as the host in a client-server relationship or to a software process that shares a resource with or performs work for one or more clients. The server 160 includes a network interface 165, processor 166, memory 167, and disk 168 all in communication with each other. Network interface 165 allows server 160 to connect to one or more networks 180. Network interface 165 may include a wireless network interface and/or a wired network interface. Processor 166 allows server 160 to execute computer readable instructions stored in memory 167 in order to perform processes described herein. Processor 166 may include one or more processing units, such as one or more CPUs and/or one or more GPUs. Memory 167 may comprise one or more types of memory (e.g., RAM, SRAM, DRAM, EEPROM, Flash, etc.). Disk 168 may include a hard disk drive and/or a solid-state drive. Memory 167 and disk 168 may comprise hardware storage devices.

The networked computing environment 100 may provide a cloud computing environment for one or more computing devices. In one embodiment, the networked computing environment 100 may include a virtualized infrastructure that provides software, data processing, and/or data storage services to end users accessing the services via the networked computing environment. In one example, networked computing environment 100 may provide cloud-based work productivity applications to computing devices, such as computing device 154. The networked computing environment 100 may provide access to protected resources (e.g., networks, servers, storage devices, files, and computing applications) based on access rights (e.g., read, write, create, delete, or execute rights) that are tailored to particular users of the computing environment (e.g., a particular employee or a group of users that are identified as belonging to a particular group or classification). An access control system may perform various functions for managing access to resources including authentication, authorization, and auditing. Authentication may refer to the process of verifying that credentials provided by a user or entity are valid or to the process of confirming the identity associated with a user or entity (e.g., confirming that a correct password has been entered for a given username). Authorization may refer to the granting of a right or permission to access a protected resource or to the process of determining whether an authenticated user is authorized to access a protected resource. Auditing may refer to the process of storing records (e.g., log files) for preserving evidence related to access control events. In some cases, an access control system may manage access to a protected resource by requiring authentication information or authenticated credentials (e.g., a valid username and password) before granting access to the protected resource. For example, an access control system may allow a remote computing device (e.g., a mobile phone) to search or access a protected resource, such as a file, web page, application, or cloud-based application, via a web browser if valid credentials can be provided to the access control system.

In some embodiments, the search and knowledge management system 120 may utilize processes that crawl the data sources 140 to identify and extract searchable content. The content crawlers may extract content on a periodic bases from files, websites, and databases and then cause portions of the content to be transferred to the search and knowledge management system 120. The frequency at which the content crawlers extract content may vary depending on the data source and the type of data being extracted. For example, a first update frequency (e.g., every hour) at which presentation slides or text files with infrequent updates are crawled may be less than a second update frequency (e.g., every minute) at which some websites or blogging services that publish frequent updates to content are crawled. In some cases, files, websites, and databases that are frequently searched or that frequently appear in search results may be crawled at the second update frequency (e.g., every two minutes) while other documents that have not appeared in search results within the past two days may be crawled at the first update frequency (e.g., once every two hours). The content extracted from the data sources 140 may be used to build a search index using portions of the content or summaries of the content. The search and knowledge management system 120 may extract metadata associated with various files and include the metadata within the search index. The search and knowledge management system 120 may also store user and group permissions within the search index. The user permissions for a document with an entry in the search index may be determined at the time of a search query or at the time that the document was indexed. A document may represent a single object that is an item in the search index, such as a file, folder, or a database record.

After the search index has been created and stored, then search queries may be accepted and ranked search results to the search queries may be generated and displayed. Only documents that are authorized to be accessed by a user may be returned and displayed. The user may be identified based on a username or email address associated with the user. The search and knowledge management system 120 may acquire one or more ACLs or determine access permissions for the documents underlying the ranked search results from the search index that includes the access permissions for the documents. The search and knowledge management system 120 may process a search query by passing over the search index and identifying content information that matches the search terms of the search query and synonyms for the search terms. The content associated with the matched search terms may then be ranked taking into account user suggested results from the user and others, whether the underlying content was verified by a content owner within a past threshold period of time (e.g., was verified within the past week), and recent messaging activity by the user and others within a common grouping. The authorized search results may be displayed with links to the underlying content or as part of personalized recommendations for the user (e.g., displaying an assigned task or a highly viewed document by others within the same group).

To generate the search index, a full crawl in which the entire content from a data source is fetched may be performed upon system initialization or whenever a new data source is added. In some cases, registered applications may push data updates; however, because the data updates may not be complete, additional full crawls may be performed on a periodic basis (e.g., every two weeks) to make sure that all data changes to content within the data sources are covered and included within the search index. In some cases, the rate of the full crawl refreshes may be adjusted based on the number of data update errors detected. A data update error may occur when documents associated with search results are out of date due to content updates or when documents associated with search results have had content changes that were not reflected in the search index at the time that the search was performed. Each data source may have a different full crawl refresh rate. In one example, full crawls on a database may be performed at a first crawl refresh rate and full crawls on files associated with a website may be performed at a second crawl refresh rate greater than the first crawl refresh rate.

An incremental crawl may fetch only content that was modified, added, or deleted since a particular time (e.g., since the last full crawl or since the last incremental crawl was performed). In some cases, incremental crawls or the fetching of only a subset of the documents from a data source may be performed at a higher refresh rate (e.g., every hour) on the most searched documents or for documents that have been flagged as having a at least a threshold number of data update errors, or that have been newly added to the organization's corpus that are searchable. In other cases, incremental crawls may be performed at a higher refresh rate (e.g., content changes are fetched every ten minutes) on a first set of documents within a data source in which content deletion occurs at a first deletion rate (e.g., some content is deleted at least every hour) and performed at a lower refresh rate (e.g., content changes are fetched every hour) on a second set of documents within the data source in which content deletion occurs at a second deletion rate (e.g., content deletions occur on a weekly basis). One technical benefit of performing incremental crawls on a subset of documents within a data source that comprise frequently searched documents or documents that have a high rate of data deletions is that the load on the data source may be reduced and the number of application programming interface (API) calls to the data source may be reduced.

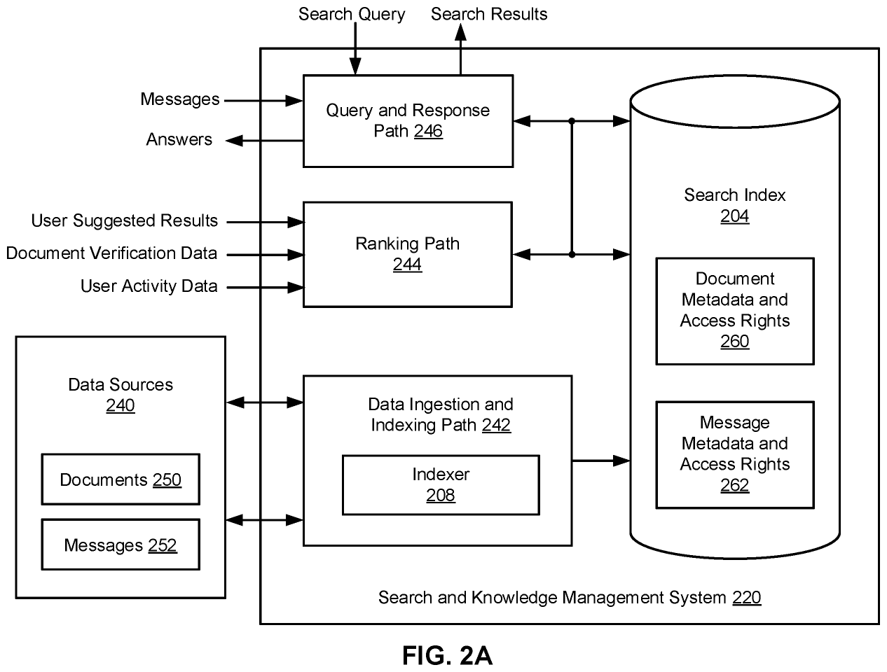

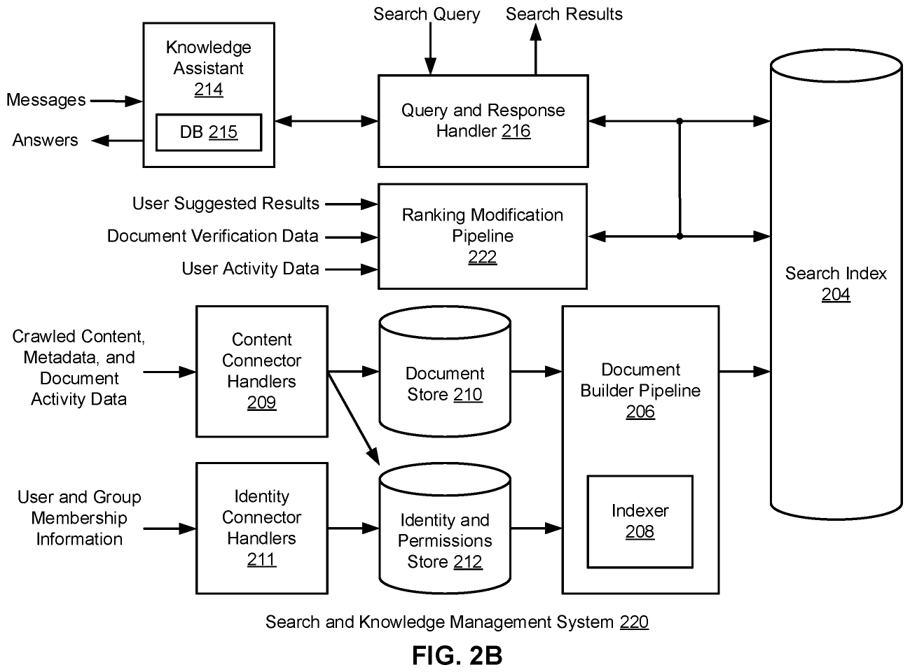

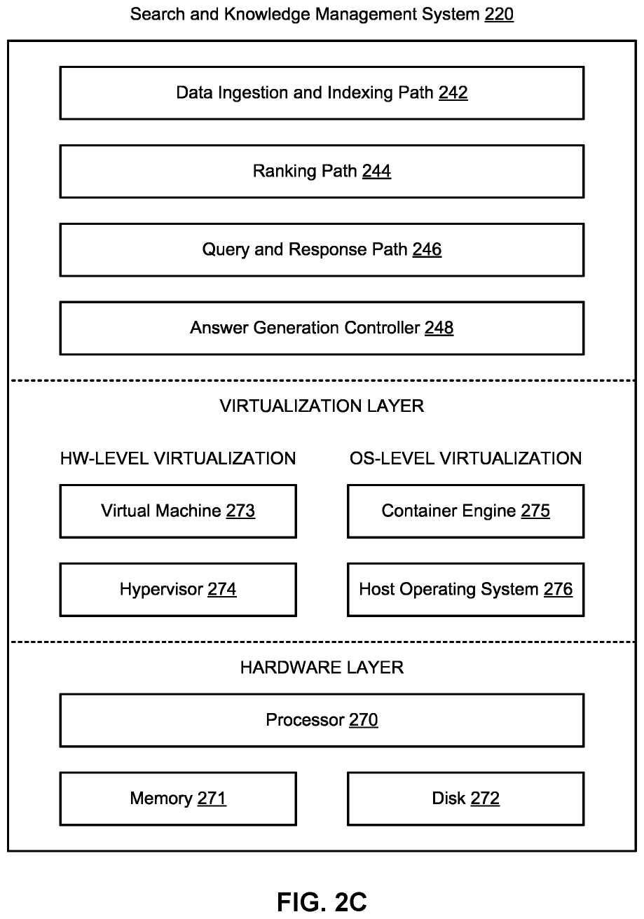

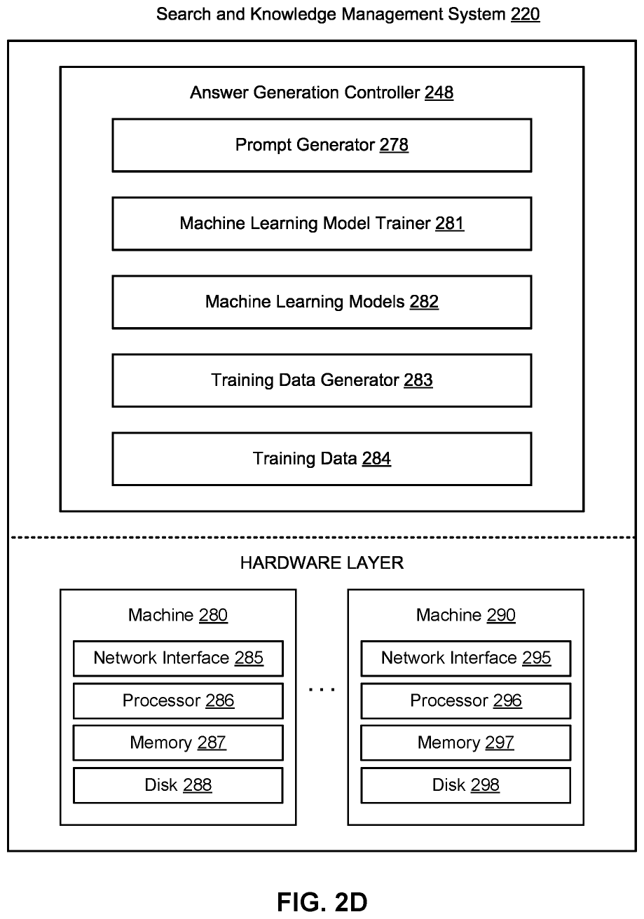

FIG. 2A depicts one embodiment of a search and knowledge management system 220 in communication with one or more data sources 240. In one embodiment, the search and knowledge management system 220 may comprise one implementation of the search and knowledge management system 120 in FIG. 1 and the data sources 240 may correspond with the data sources 140 in FIG. 1. The data sources 240 may include one or more electronic documents 250 and one or more electronic messages 252 that are stored over various networks, document and content management systems, file servers, database systems, desktop computers, portable electronic devices, mobile phones, cloud-based applications, and cloud-based services.

The search and knowledge management system 220 may comprise a cloud-based system that includes a data ingestion and index path 242, a ranking path 244, a query and response path 246, and a search index 204. The search index 204 may store a first set of index entries for the one or more electronic documents 250 including document metadata and access rights 260 and a second set of index entries for the one or more electronic messages 252 including message metadata and access rights 262. The data ingestion and index path 242 may crawl a corpus of documents within the data sources 240, index the documents and extract metadata for each document fetched from the data sources 240, and then store the metadata in the search index 204. An indexer 208 within the data ingestion and index path 242 may write the metadata to the search index 204. In one example, if a fetched document comprises a text file, then the metadata for the document may include information regarding the file size or number of words, an identification of the author or creator of the document, when the document was created and last modified, key words from the document, a summary of the document, and access rights for the document. The query and response path 246 may receive a search query from a user computing device, such as the computing device 154 in FIG. 1, and compare the search query and terms derived from the search query (e.g., synonyms and related terms) with the search index 204 to identify relevant documents for the search query. The query and response path 246 may also include or interface with an automated digital assistant that may interact with a user of the user computing device in a conversational manner in which answers are outputted in response to messages or questions provided to the automated digital assistant.

The relevant documents may be ranked using the ranking path 244 and then a set of search results responsive to the search query may be outputted to the user computing device corresponding with the ranking or ordering of the relevant documents. The ranking path 244 may take into consideration a variety of signals to score and rank the relevant documents. The ranking path 244 may determine the ranking of the relevant documents based on the number of times that a search query term appears within the content or metadata for a document, whether the search query term matches a key word for a document, and how recently a document was created or last modified. The ranking path 244 may also determine the ranking of the relevant documents based on user suggested results from an owner of a relevant document or the user executing the search query, the amount of time that has passed since the user suggested result was established, whether a document was verified by a content owner, the amount of time that has passed since the relevant document was verified by the content owner, and the amount and type of activity performed with a past period of time (e.g., within the past hour) by the user executing the search query and related group members.

FIG. 2B depicts one embodiment of the search and knowledge management system 220 of FIG. 2A. The search and knowledge management system 220 may comprise a cloud-based system that includes a data ingestion and indexing path, a ranking path, a query path, and a search index 204. The components of the search and knowledge management system 220 may be implemented using software, hardware, or a combination of hardware and software. In some cases, a cloud-based task service for asynchronous execution, cloud-based task handlers, or a cloud-based system for managing the execution, dispatch, and delivery of distributed tasks may be used to implement the fetching and processing of content from various data sources, such as data sources 240 in FIG. 2A. In some cases, a cloud-based task service or a cloud-based system for managing the execution, dispatch, and delivery of distributed tasks may be used to acquire and synchronize user and group identifications associated with content fetched from the various data sources. The data sources may have dedicated task queues or shared task queues depending on the size of the data source and the rate requirements for fetching the content. In one example, a data source may have a dedicated task queue if the data source stores more than a threshold number of documents or more than a threshold amount of content (e.g., stores more than 100 GB of data).

The data ingestion and indexing path is responsible for periodically acquiring content and identity information from the data sources 240 in FIG. 2A and adding the content and identity information or portions thereof to the search index 204. The data ingestion and indexing path includes content connector handlers 209 in communication with document store 210. The document store 210 may comprise a key value store database or a cloud-based database service. The content connector handlers 209 may comprise software programs or applications that are used to traverse and fetch content from one or more data sources. The content connector handlers 209 may make API calls to various data sources, such as the data sources 240 in FIG. 2A, to fetch content and data updates from the data sources. Each data source may be associated with one content connector for that data source. The content connector handlers 209 may acquire content, metadata, and activity data corresponding with the content. For example, the content connector handlers 209 may acquire the text of a word processing document, metadata for the word processing document, and activity data for the word processing document. The metadata for the word processing document may include an identification of the owner of the document, a timestamp associated with when the document was last modified, a file size for the document, and access permissions for the document. The activity data for the word processing document may include the number of views for the document within a threshold period of time (e.g., within the past week or since the last update to the document occurred), the number of likes for the document, the number of downloads for the document, and the number of shares associated with the document. The content connector handlers 209 may store the fetched content, metadata, and activity data in the document store 210 and publish the fetch event to a publish-subscribe (pubsub) system not depicted so that the document builder pipeline 206 may be notified that the fetch event has occurred. In response to the notification, the document builder pipeline 206 may process the fetched content and add the fetched content and information derived from the fetched content to the search index 204. The document builder pipeline 206 may transform or augment the fetched content prior to storing the information derived from the fetched content in the search index 204. In one example, the document builder pipeline 206 may augment the fetched content with identity information and synonyms.

Some data sources may utilize APIs that provide notification (e.g., via webhook pings) to the content connector handlers 209 that content within a data source has been modified, added, or deleted. For data sources that are not able to provide notification that content updates have occurred or that cannot push content changes to the content connector handlers 209, the content connector handlers 209 may perform periodic incremental crawls in order to identify and acquire content changes. In some cases, the content connector handlers 209 may perform periodic incremental crawls or full crawls even if a data source has provided webhook pings in the past in order to ensure the integrity of the acquired content and that the search and knowledge management system 220 is consistent with the actual state of the content stored in the data source. Some data sources may allow applications to register for callbacks or push notifications whenever content or identity information has been updated at the data source.

As depicted in FIG. 2B, the data ingestion and indexing path also includes identity connector handlers 211 in communication with identity and permissions store 212. The identity and permissions store 212 may comprise a key value store database or a cloud-based database service. The identity connector handlers 211 may acquire user and group membership information from one or more data sources and store the user and group membership information in the identity and permissions store 212 to enable search results that respect data source specific privacy settings for the content stored using the one or more data sources. The user information may include data source specific user information, such as a data source specific user identification or username. The identity connector handlers 211 may comprise software programs or applications that are used to acquire and synchronize user and/or group identities to a primary identity used by the search and knowledge management system 220 to uniquely identify a user. Each user of the search and knowledge management system 220 may be canonically represented via a unique primary identity, which may comprise a hash of an email address for the user. In some cases, the search and knowledge management system 220 may map an email address that is used as the primary identity for a user to an alphanumeric username used by a data source to identify the same user. In other cases, the search and knowledge management system 220 may map a unique alphanumeric username that is used as the primary identity for a user to two different usernames that are used by a data source to identify the same user, such as one username associated with regular access permissions and another username associated with administrative access permissions. If a data source does not identify a user by the user's primary identity within the search and knowledge management system 220, then an external identity that identifies the user for that data source may be determined by the search and knowledge management system 220 and mapped to the primary identity.

In some cases, the content connector handlers 209 may fetch access rights and permissions settings associated with the fetched content during the content crawl and store the access rights and permission settings using the identity and permissions store 212. For some data sources, the identity crawl to obtain user and group membership information may be performed before the content crawl to obtain content associated with the user and group membership information. When a document is fetched during the content crawl, the content connector handlers 209 may also fetch the ACL for the document. The ACL may specify the allowed users with the ability to view or access the document, the disallowed users that do not have access rights to view or access the document, allowed groups with the ability to view or access the document, and disallowed groups that do not have access rights to view or access the document. The ACL for the document may indicate access privileges for the document including which individuals or groups have read access to the document.

In some cases, a particular set of data may be associated with an ACL that determines which users within an organization may access the particular set of data. In one example, to ensure compliance with data security and retention regulations, the particular set of data may comprise sensitive or confidential information that is restricted to viewing by only a first group of users. In another example, the particular set of data may comprise source code and technical documentation for a particular product that is restricted to viewing by only a second group of users.

As depicted in FIG. 2B, the document store 210 may store crawled content from various data sources, along with any transformation or processing of the content that occurs prior to indexing the crawled content. Every piece of content acquired from the data sources may correspond with a row in the document store 210. For example, when the content connector handlers 209 fetch a spreadsheet or word processing document from a data source, the raw content for the spreadsheet or word processing document may be stored as a row in the document store 210. In addition to the raw content, a row in the document store 210 may also include interaction or activity data associated with the content, such as the number of views, the number of comments, the number of likes, and the number of users who interacted with the content along with their corresponding user identifications. A row in the document store 210 may also include document metadata for the stored content, such as keywords or classification information, and permissions or access rights information for the stored content.

The identity and permissions store 212 may store the primary identity for a user (e.g., a hash of an email address) within the search and knowledge management system 220 and corresponding usernames or data source identifiers used by each data source for the same user. A row in the identity and permissions store 212 may include a mapping from the user identifier used by a data source to the corresponding primary identity for the user for the search and knowledge management system 220. The identity and permissions store 212 may also store identifications for each user assigned to a particular group or associated with a particular group membership. The ACLs that are associated with a fetched document may include allowed user identifications and allowed group identifications. Each user of the search and knowledge management system 220 may correspond with a unique primary identity and each primary identity may be mapped to all groups that the user is a member of across all data sources.

As depicted in FIG. 2B, the data ingestion and indexing path includes document builder pipeline 206 in communication with search index 204. The document builder pipeline 206 may comprise software programs or applications that are used to transform or augment the crawled content to generate searchable documents that are then stored within the search index 204. The document builder pipeline 206 may include an indexer 208 that writes content derived from the fetched content, structured metadata for the fetched content, and access rights for the fetched content to the search index 204.

The searchable documents generated by the document builder pipeline 206 may comprise portions of the crawled content along with augmented data, such as access right information, document linking information, search term synonyms, and document activity information. In one example, the document builder pipeline 206 may transform the crawled content by extracting plain text from a word processing document, a hypertext markup language (HTML) document, or a portable document format (PDF) document and then directing the indexer 208 to write the plain text for the document to the search index 204. A document parser may be used to extract the plain text for the document or to generate clean text for the document that can be indexed (e.g., with HTML tags or text formatting tags removed). The document builder pipeline 206 may also determine access rights for the document and write the identifications for the users and groups with access rights to the document to the search index 204. The document builder pipeline 206 may determine document linking information for the crawled document, such as a list of all the documents that reference the crawled document and their anchor descriptions, and store the document linking information in the search index 204. The document linking information may be used to determine document popularity (e.g., based on how many times a document is referenced or the number of outlinks from the document) and preserve searchable anchor text for target documents that are referenced. The words or terms used to describe an outgoing link in a source document may provide an important ranking signal for the linked target document if the words or terms accurately describe the target document. The document builder pipeline 206 may also determine document activity information for the crawled document, such as the number of document views, the number of comments or replies associated with the document, and the number of likes or shares associated with the document, and store the document activity information in the search index 204.

The document builder pipeline 206 may be subscribed to publish-subscribe events that get written by the content connector handlers 209 every time new documents or updates are added to the document store 210. Upon notification that the new documents or updates have been added to the document store 210, the document builder pipeline 206 may perform processes to transform or augment the new documents or portions thereof prior to generating the searchable documents to be stored within the search index 204.

As depicted in FIG. 2B, the query path includes a query and response handler 216 in communication with the search index 204 and the ranking modification pipeline 222. A knowledge assistant 214 interacts with the query and response handler 216 to provide a real-time automated digital assistant that may interact with a user of the search and knowledge management system 220 via a graphical user interface in a conversational manner using natural language dialog. The automated digital assistant may comprise a computer-implemented assistant that may access and display only information that a user's access rights permit. The knowledge assistant 214 may include a frequently asked questions (FAQ) database that includes question and answer pairs for questions identified within a chat channel that were classified as factual questions. The FAQ database may be stored in database DB 215 or in a solid-state memory not depicted.

The query and response handler 216 may comprise software programs or applications that detect that a search query has been submitted by an authenticated user identity, parse the search query, acquire query metadata for the search query, identify a primary identity for the authenticated user identity, acquire ranked search results that satisfy the search query using the primary identity and the parsed search query, and output (e.g., transfer or display) the ranked search results that satisfy the search query or that comprise the highest ranking of relevant information for the search query and the query metadata. The search query may be parsed by acquiring an inputted search query string for the search query and identifying root terms or tokenized terms within the search query string, such as unigrams and bigrams, with corresponding weights and synonyms. In some cases, natural language processing algorithms may be used to identify terms within a search query string for the search query. The search query may be received as a string of characters and the natural language processing algorithms may identify a set of terms (or a set of tokens) from the string of characters. Potential spelling errors for the identified terms may be detected and corrected terms may be added or substituted for the potentially misspelled terms.

The query metadata may include synonyms for terms identified within the search query and nearest neighbors with semantic similarity (e.g., with semantic similarity scores above a threshold that indicate their similarity to each other at the semantic level). The semantic similarity between two texts (e.g., each comprising one or more words) may refer to how similar the two texts are in meaning. A supervised machine learning approach may be used to determine the semantic similarity between the two texts in which training data for the supervised step may include sentence or phrase pairs and the associated labels that represent the semantic similarly between the sentence or phrase pairs. The query and response handler 216 may consume the search query as a search query string, and then construct and issue a set of queries related to the search query based on the terms identified within the search query string and the query metadata. In response to the set of queries being issued, the query and response handler 216 may acquire a set of relevant documents for the set of queries from the search index 204. The set of relevant documents may be provided to the ranking modification pipeline 222 to be scored and ranked for relevance to the search query. After the set of relevant documents have been ranked, a subset of the set of relevant documents may be identified (e.g., the top thirty ranked documents) based on the ranking and summary information or snippets may be acquired from the search index 204 for each document of the subset of the set of relevant documents. The query and response handler 216 may output the ranked subset of the set of relevant documents and their corresponding snippets to a computing device used by the authenticated user, such as the computing device 154 in FIG. 1.

Moreover, when a user issues a search query, the query and response handler 216 may determine the primary identity for the authenticated user and then query the identity and permissions store 212 to acquire all groups that the user is a member of across all data sources. The query and response handler 216 may then query the search index 204 with a filter that restricts the retrieved set of relevant documents such that the ACLs for the retrieved documents permit the user to access or view each of the retrieved set of relevant documents. In this case, each ACL should either specify that the user comprises an allowed user or that the user is a member of an allowed group.

The search index 204 may comprise a database that stores searchable content related to documents stored within the data sources 240 in FIG. 2A. The search index 204 may store text, title strings, chat message bodies, metadata, and access rights related to searchable content. For each searchable document, portions of text associated with the document, extracted key words, document classifications, and document summaries may be stored within the search index 204. For searchable electronic messages (e.g., searchable chat messages or email messages), the title, the message body of the original message, and the message bodies of related messages may be stored within the search index 204. For searchable question and answer responses, the message body of the question and the message body of the answer may be stored within the search index 204. A question and answer pair may derive from questions and answers made by the user or made by other users (e.g., co-workers) during a conversation exchange within a persistent chat channel or from dialog between an artificial intelligence powered digital assistant and the user within a chat channel. One example of an artificial intelligence powered digital assistant is the knowledge assistant 214 that may automatically output answers to messages or questions provided to the digital assistant. Text associated with other documents linked to or referenced by a searchable document, electronic message, or question and answer pair may also be stored within the search index 204 to provide context for the searchable content. Content access rights including which users and groups are allowed to access the content may be stored within the search index 204 for each piece of searchable content.

As depicted in FIG. 2B, the ranking modification pipeline 222 may comprise software programs or applications that are used to score and rank documents and portions of documents. The scoring of a set of relevant documents may weight different attributes of the documents differently. In one example, literal matches or lexical matches of search query terms within the body of a message or document may correspond with a first weighting while semantic matches of the search query terms may correspond with a second weighting different from the first weighting (e.g., greater than the first weighting). The matching of search query terms or their synonyms within a message body may be given a first weighting while the matching of the search query terms within a title field or within the text of a referencing document (e.g., anchor text within a source document) may be given a second weighting different from the first weighting (e.g., greater than the first weighting). The scoring and ranking of a set of relevant documents may take into consideration document popularity, which may change over time as a document ages or as the number of views for a document within a past period of time (e.g., within the past week) increases or decreases. A higher document popularity score may increase the ranking of a document, while a lower document popularity score may signal that the document has become stale and that its importance should be demoted. The ranking modification pipeline 222 may score and rank a set of relevant documents based on user suggested results submitted by owners of the relevant documents, the document verification statuses of the relevant documents, and the amount and type of user activity performed within a past period of time (e.g., within the past 24 hours) by the user executing a search query and others that are part of a common grouping with the user (e.g., co-workers on the same team or assigned to the same group).

FIG. 2C depicts one embodiment of various components of the search and knowledge management system 220 of FIG. 2A. As depicted, the search and knowledge management system 220 includes hardware-level components and software-level components. The hardware-level components may include one or more processors 270, one or more memory 271, and one or more disks 272. The software-level components may include software applications and computer programs. In some embodiments, the data ingestion and index path 242, the ranking path 244, the query and response path 246, and the answer generation controller 248 may be implemented using software or a combination of hardware and software. In some cases, the software-level components may be run using a dedicated hardware server. In other cases, the software-level components may be run using a virtual machine or containerized environment running on a plurality of machines. In various embodiments, the software-level components may be run from the cloud (e.g., the software-level components may be deployed using a cloud-based compute and storage infrastructure).

In some embodiments, the answer generation controller 248 may determine when to leverage one or more generative AI models in order to generate summaries of search results. The answer generation controller 248 may also determine the number of search results and/or the amount of text per search result to provide to the one or more generative AI models based on latency requirements for providing responses to search queries.

As depicted in FIG. 2C, the software-level components may also include virtualization layer processes, such as virtual machine 273, hypervisor 274, container engine 275, and host operating system 276. The hypervisor 274 may comprise a native hypervisor (or bare-metal hypervisor) or a hosted hypervisor (or type 2 hypervisor). The hypervisor 274 may provide a virtual operating platform for running one or more virtual machines, such as virtual machine 273. A hypervisor may comprise software that creates and runs virtual machine instances. Virtual machine 273 may include a plurality of virtual hardware devices, such as a virtual processor, a virtual memory, and a virtual disk. The virtual machine 273 may include a guest operating system that has the capability to run one or more software applications, such as applications for the data ingestion and index path 242, the ranking path 244, and the query and response path 246. The virtual machine 273 may run the host operation system 276 upon which the container engine 275 may run.

A container engine 275 may run on top of the host operating system 276 in order to run multiple isolated instances (or containers) on the same operating system kernel of the host operating system 276. Containers may facilitate virtualization at the operating system level and may provide a virtualized environment for running applications and their dependencies. Containerized applications may comprise applications that run within an isolated runtime environment (or container). The container engine 275 may acquire a container image and convert the container image into running processes. In some cases, the container engine 275 may group containers that make up an application into logical units (or pods). A pod may contain one or more containers and all containers in a pod may run on the same node in a cluster. Each pod may serve as a deployment unit for the cluster. Each pod may run a single instance of an application.

FIG. 2D depicts another embodiment of various components of the search and knowledge management system 220 of FIG. 2A. The search and knowledge management system 220 of FIG. 2A may utilize one or more machine learning models to determine a selection and ranking of relevant documents. As depicted, the answer generation controller 248 includes prompt generator 278, machine learning model trainer 281, machine learning models 282, training data generator 283, and training data 284. The prompt generator 278 generates input prompt to be provided to generative AI models. The machine learning models 282 may comprise one or more machine learning models that are stored in a memory, such as memory 127 in FIG. 1 or memory 271 in FIG. 2C. The one or more machine learning models may be trained, executed, and/or deployed using one or more processors, such as processor 126 in FIG. 1 or processor 270 in FIG. 2C. The one or more machine learning models may include neural networks (e.g., deep neural networks), support vector machine models, decision tree-based models, k-nearest neighbor models, Bayesian networks, or other types of models such as linear models and/or non-linear models. A linear model may be specified as a linear combination of input features. A neural network may comprise a feed-forward neural network, recurrent neural network, or a convolutional neural network.

The search and knowledge management system 220 may also include a set of machines including machine 280 and machine 290. In some cases, the set of machines may be grouped together and presented as a single computing system. Each machine of the set of machines may comprise a node in a cluster (e.g., a failover cluster). The cluster may provide computing and memory resources for the search and knowledge management system 220. In one example, instructions and data (e.g., input feature data) may be stored within the memory resources of the cluster and used to facilitate operations and/or functions performed by the computing resources of the cluster. The machine 280 includes a network interface 285, processor 286, memory 287, and disk 288 all in communication with each other. Processor 286 allows machine 280 to execute computer readable instructions stored in memory 287 to perform processes described herein. Disk 288 may include a hard disk drive and/or a solid-state drive. The machine 290 includes a network interface 295, processor 296, memory 297, and disk 298 all in communication with each other. Processor 296 allows machine 290 to execute computer readable instructions stored in memory 297 to perform processes described herein. Disk 298 may include a hard disk drive and/or a solid-state drive. In some cases, disk 298 may include a flash-based SSD or a hybrid HDD/SSD drive.

In one embodiment, the depicted components of the search and knowledge management system 220 including the machine learning model trainer 281, machine learning models 282, training data generator 283, and training data 284 may be implemented using the set of machines. In another embodiment, one or more of the depicted components of the search and knowledge management system 220 may be run in the cloud or in a virtualized environment that allows virtual hardware to be created and decoupled from the underlying physical hardware.

The machine learning model trainer 281 may implement a machine learning algorithm that uses a training data set from the training data 284 to train the machine learning model and uses the evaluation data set to evaluate the predictive ability of the trained machine learning model. The predictive performance of the trained machine learning model may be determined by comparing predicted answers generated by the trained machine learning model with the target answers in the evaluation data set (or ground truth values). For a linear model, the machine learning algorithm may determine a weight for each input feature to generate a trained machine learning model that can output a predicted answer. In some cases, the machine learning algorithm may include a loss function and an optimization technique. The loss function may quantify the penalty that is incurred when a predicted answer generated by the machine learning model does not equal the appropriate target answer. The optimization technique may seek to minimize the quantified loss. One example of an appropriate optimization technique is online stochastic gradient descent.

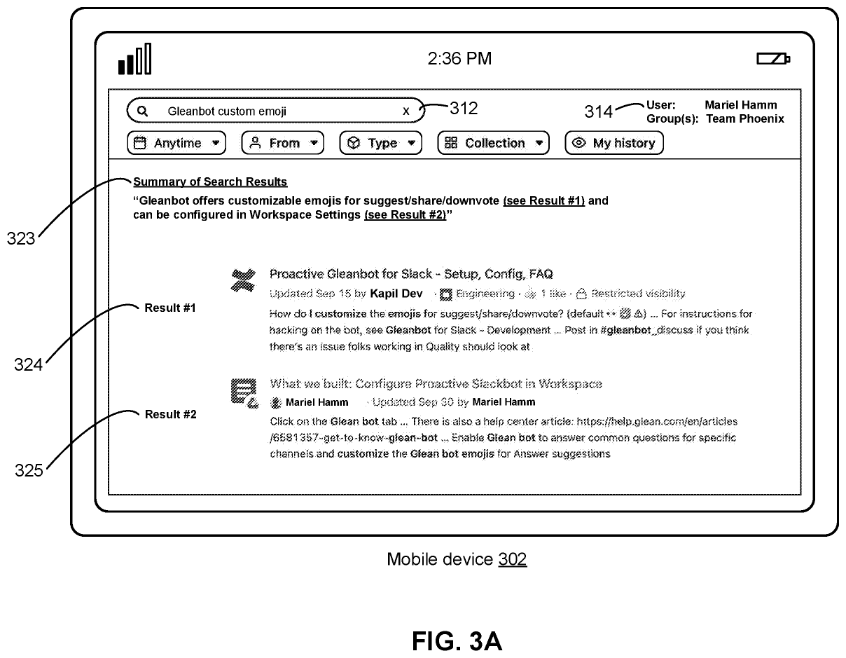

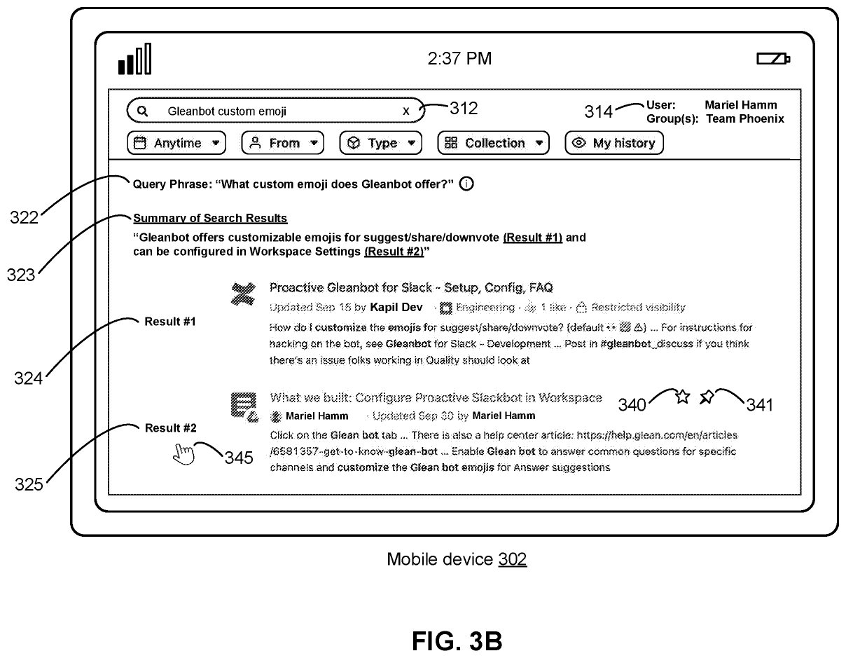

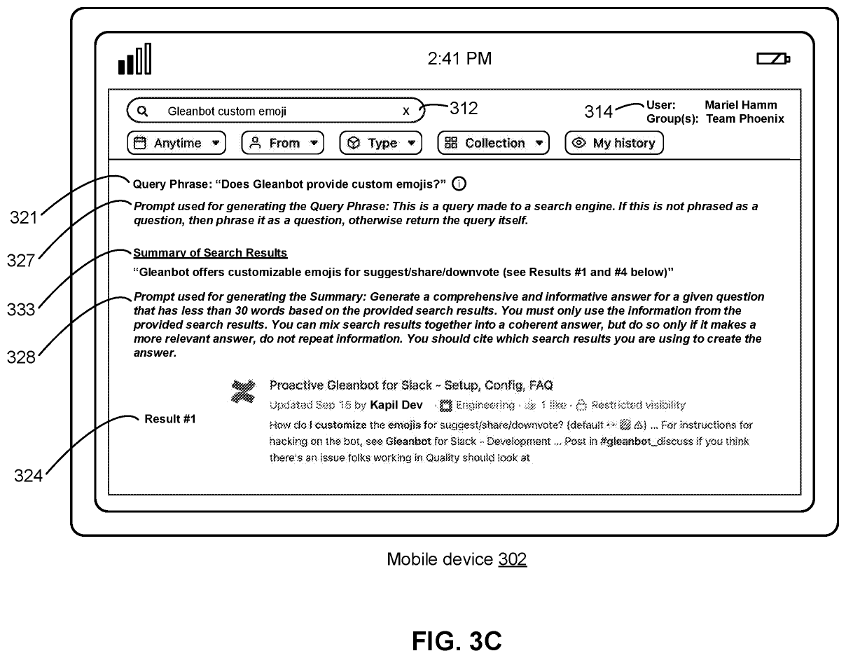

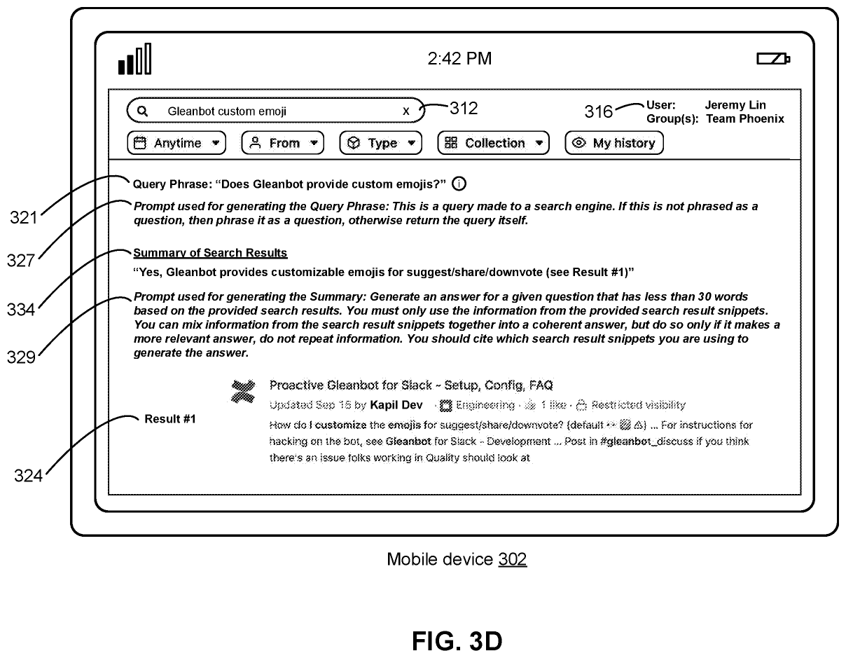

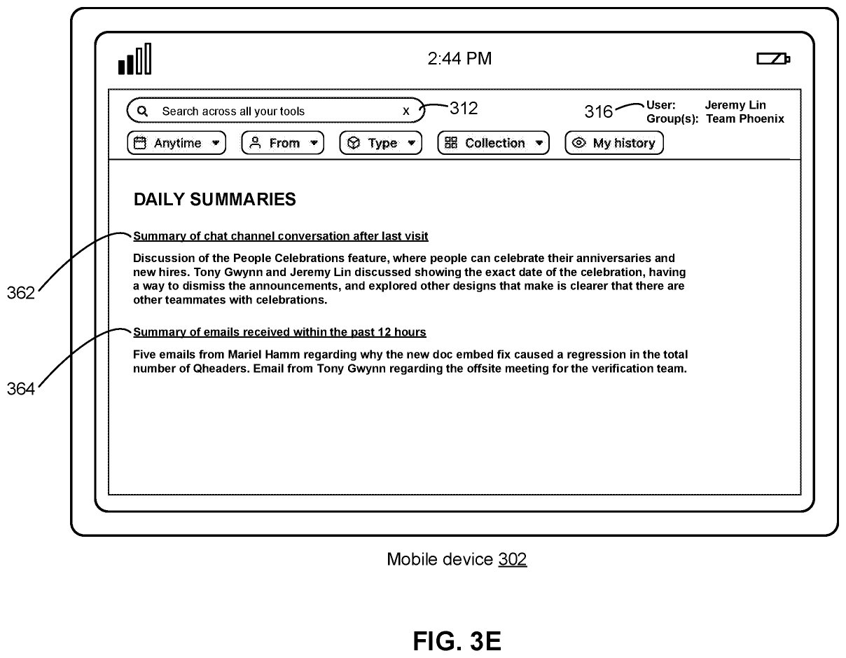

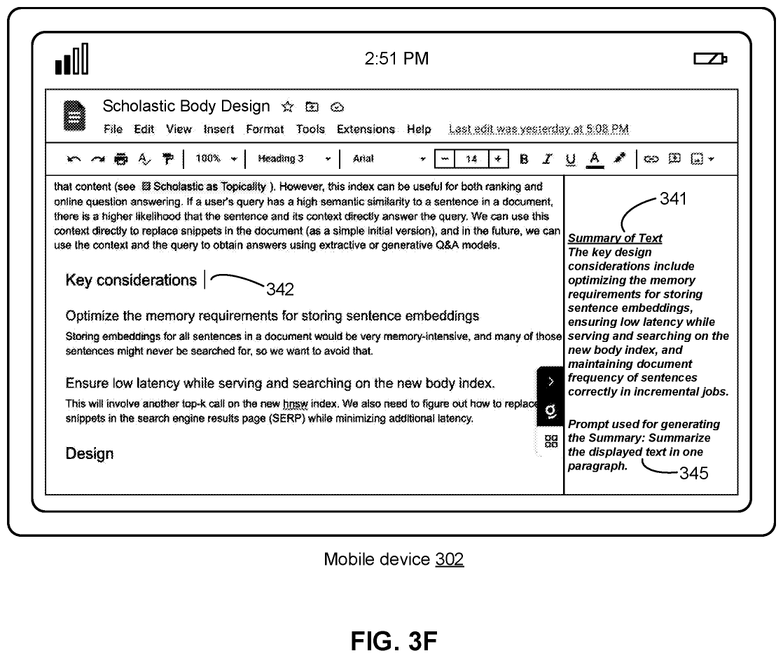

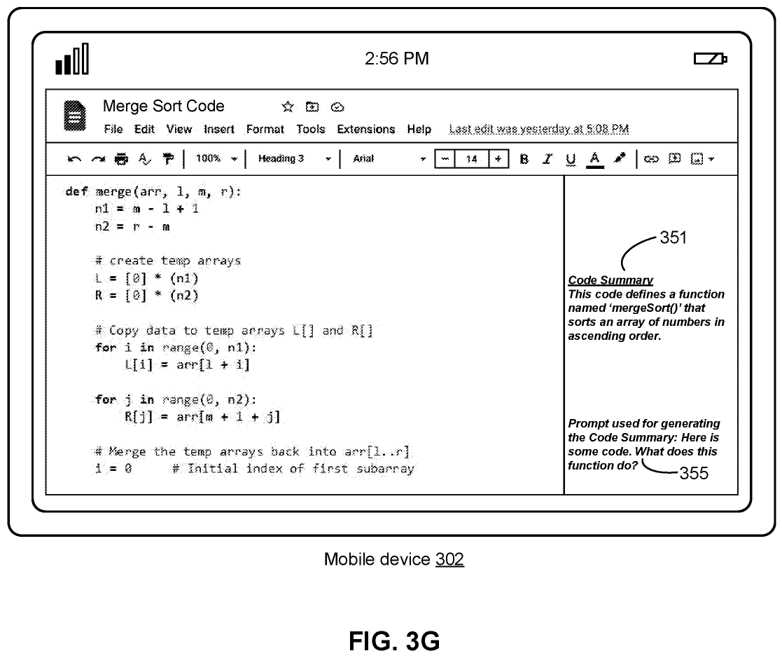

FIG. 3A depicts one embodiment of a mobile device 302 providing a user interface for interacting with a permissions-aware search and knowledge management system. In one example, the mobile device 302 may correspond with the computing device 154 in FIG. 1. The mobile device 302 may include a touchscreen display that displays a user interface to an end user of the mobile device 302. The mobile device 302 may display device status information regarding wireless signal strength, time, and battery life associated with the mobile device, as well as the user interface for controlling or interacting with the permissions-aware search and knowledge management system. The user interface may be provided via a web-browser or an application running on the mobile device. The user interface may include a search bar 312 that the end user of the mobile device 302 may use to enter and submit a search query with search terms and criteria for the permissions-aware search and knowledge management system. The end user of the mobile device 302 may be associated with a unique user identifier or username 314. The username 314 may map to one or more group identifiers or group names. For example, the username “Mariel Hamm” may map to a single group identifier “Team Phoenix.” A username may map to one or more group identifiers (e.g., a username may map to three different group identifiers associated with three different groups).

As depicted in FIG. 3A, a search query of “Gleanbot custom emoji” has been entered into the search bar 312 and in response a summary of search results 323 has been displayed. The summary of search results 323 includes references to Result #1 that refers to the first search result 324 and Result #2 that refers to the second search result 325. The summary of search results 323 may have been generated using one or more generative AI models in which a prompt to the one or more generative AI models includes portions of the first search result 324 and the second search result 325.

FIG. 3B depicts one embodiment of the mobile device 302 providing a user interface for interacting with the permissions-aware search and knowledge management system. As depicted, a search query of “Gleanbot custom emoji” has been entered into the search bar 312 and in response a summary of search results 323 has been displayed. In order to generate the search results including the first search result 324 and the second search result 325, a natural language query phrase 322 has been generated using a first generative AI model and the keywords from the search query of “Gleanbot custom emoji.” In some cases, generating the natural language query phrase 322 may improve the quality of the search results generated using the permissions-aware search and knowledge management system.

As depicted in FIG. 3B, upon detection that the mouse pointer 345 is hovering over the second search result 325, a pin icon 341 for pinning the content underlying the second search result 325 to the search query is displayed and a star icon 340 for selecting the entered search query as the user's best search result is displayed.

FIG. 3C depicts one embodiment of the mobile device 302 providing a user interface for interacting with the permissions-aware search and knowledge management system. As depicted, a search query of “Gleanbot custom emoji” has been entered into the search bar 312 and in response a summary of search results 333 different from the summary of search results 323 in FIG. 3B has been displayed. The difference in the summary of search results may be attributed to a change in the prompt used to generate the summary of search results 333. The natural language query phrase 321 is different from the natural language query phrase 322 in FIG. 3B. One reason for the difference may be due to the use of different input prompts for generating the query phrases. The natural language query phrase 321 may be generated as a completion to the prompt 327. The prompt 328 may be used to generate the summary of search results 333. In one embodiment, the prompt 327 with the search query may be used to generate the query phrase 321 and the prompt 328 with the search results including the first search result 324 may be used to generate the summary of search results 333. In some cases, the full text of each of the search results along with the prompt 328 may be provided to a generative AI model to generate the summary of search results 333. In other cases, only a portion of the full text of each of the search results may be provided to the generative AI model to generate the summary of search results 333. In one example, the size of the portion of the full text may depend on a latency requirement for generating the summary of search results 333 or the maximum amount of time allowed to generate a summary of search results after a search query has been submitted.

FIG. 3D depicts one embodiment of the mobile device 302 providing a user interface for interacting with the permissions-aware search and knowledge management system. As depicted, a summary of search results 334 different from the summary of search results 333 in FIG. 3C has been displayed. One reason for the difference may be due to the use of different input prompts for generating the summary of the search results. The prompt 329 is not the same as the prompt 328 in FIG. 3C. In some cases, a change in a username or user identifier, such as changing from username 314 in FIG. 3C to the username 316 in FIG. 3D may lead to different input prompts to be used for generating a natural language query phrase and/or a summary of search results.

FIG. 3E depicts one embodiment of the mobile device 302 providing a user interface for interacting with the permissions-aware search and knowledge management system. As depicted, a summary of a chat channel conversation 362 and a summary of emails received within a past threshold period of time (e.g., the past 12 hours) is displayed. In one embodiment, the summary of the chat channel conversation 362 may be automatically generated using a generative AI model and displayed in response to detection that an end user of the mobile device 302 has opened a chat application or in response to detection that the end user has not visited the chat channel within a threshold period of time (e.g., the end user hasn't visited the chat channel within the past ten hours).

FIG. 3F depicts one embodiment of the mobile device 302 providing a user interface for interacting with the permissions-aware search and knowledge management system. As depicted, as an end user of the mobile device 302 is editing a word processing document, a summary of text 341 is automatically displayed. The summary of text 341 may be generated using the prompt 345 that causes the text displayed by the mobile device 302 to be summarized. In one embodiment, the summary of text 341 may be generated based on a cursor location 342 or the locations of recent edits made to the word processing document.

In one embodiment, a search query may be automatically implied or submitted based on text surrounding the cursor location 342. If the text surrounding the cursor location 342 comprises a highly ranked or commonly asked question, then the search query may be submitted, search results may be generated for the search query, and a summary for the search results may be generated and displayed.

FIG. 3G depicts one embodiment of the mobile device 302 providing a user interface for interacting with the permissions-aware search and knowledge management system. As depicted, as an end user of the mobile device 302 is editing source code for a computer program, a summary of code 351 is automatically displayed. The summary of code 351 may be generated using the prompt 355 that causes the code displayed by the mobile device 302 to be summarized. In some cases, the identification of the language used for a prompt may depend on the type of file being edits. For example, the prompt used for summarizing computer program code may be different from the prompt used for summarizing portions of text within a word processing document.

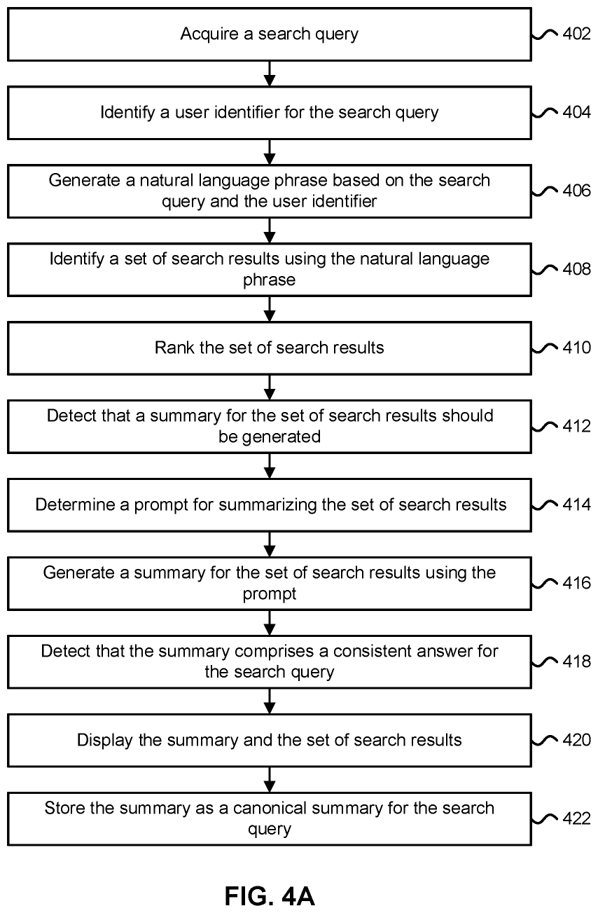

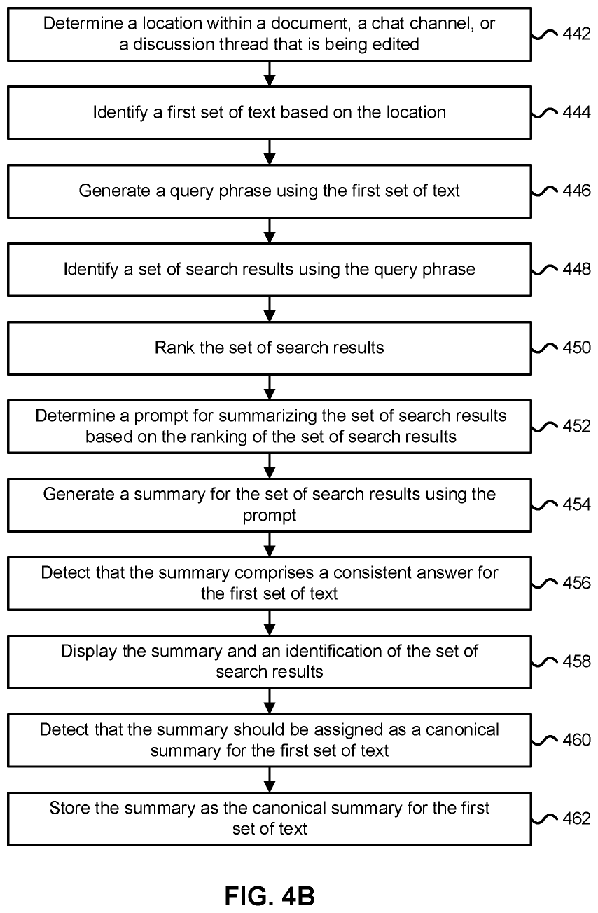

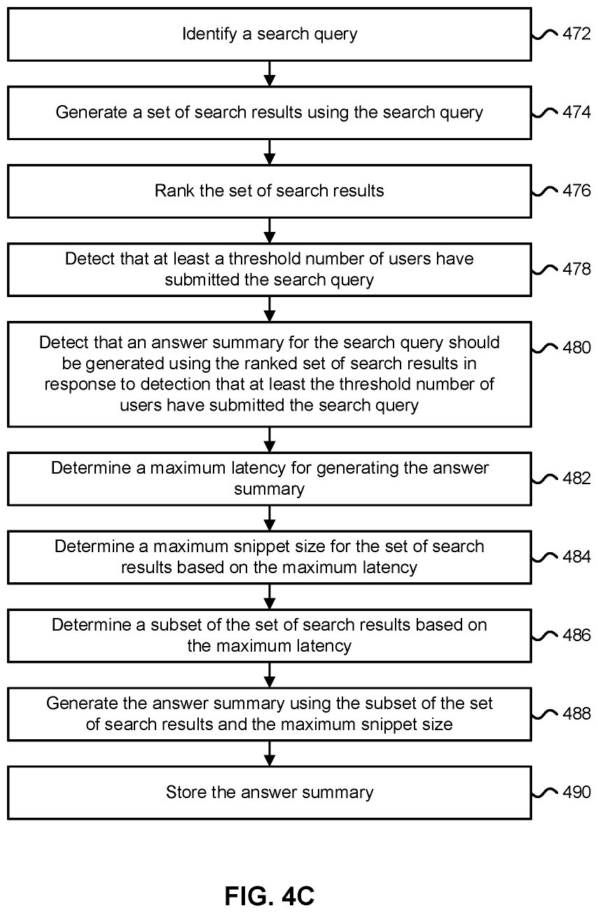

FIG. 4A depicts a flowchart describing one embodiment of a process for generating and displaying a summary of search results for a given search query. In one embodiment, the process of FIG. 4A may be performed by a search and knowledge management system, such as the search and knowledge management system 120 in FIG. 1 or the search and knowledge management system 220 in FIG. 2A. In another embodiment, the process of FIG. 4A may be implemented using a cloud-based computing platform or cloud-based computing services.

In step 402, a search query is acquired. The search query may be acquired from a search bar, such as the search bar 312 in FIG. 3C. In step 404, a user identifier for the search query is identified. The user identifier may uniquely identify an end user of a computing device or application. In step 406, a natural language phrase is generated based on the search query and the user identifier. The natural language phrase may be generated using a generative AI model and a prompt, such as the prompt 327 in FIG. 3C. The generative AI model may comprise one of the machine learning models 282 in FIG. 2D. In step 408, a set of search results is identified using the natural language phrase. In one embodiment, the set of search results may be generated using a search and knowledge management system or a search engine. The set of search results may include the first search result 324 in FIG. 3C. In step 410, the set of search results is ranked. The set of search results may be ranked based on the relevance of the search results to the search query acquired in step 402.

In step 412, it is detected that a summary for the set of search results should be generated. In one embodiment, it may be detected that the summary for the set of search results should be generated in response to detection that at least a threshold number of end users have submitted search queries for substantially the same search query or for semantically similar search queries. In step 414, a prompt for summarizing the set of search results is determined. In one example, the prompt for summarizing the set of search results may be obtained from a lookup table based on the user identifier and/or a type of document being edited.

In step 416, a summary for the set of search results is generated using the prompt. In one example, the prompt for generating the summary for the set of search results may correspond with the prompt 328 in FIG. 3C. In step 418, it is detected that the summary comprises a consistent answer for the search query. In one example, it may be detected that the summary comprises a consistent answer for the search query by prompting a generative AI model to confirm that the summary comprises a consistent answer for the search query. In step 420, the summary and the set of search results are displayed. In step 422 the summary is stored as a canonical summary for the search query. The summary may be stored using a database, such as the database DB 215 in FIG. 2B.

FIG. 4B depicts a flowchart describing one embodiment of a process for generating a summary of search results for a given search query and storing the summary as a canonical summary. In one embodiment, the process of FIG. 4B may be performed by a search and knowledge management system, such as the search and knowledge management system 120 in FIG. 1 or the search and knowledge management system 220 in FIG. 2A. In another embodiment, the process of FIG. 4B may be implemented using a cloud-based computing platform or cloud-based computing services.

In step 442, a location within a document, a chat channel, or a discussion thread that is being edited is determined. In one example, the location may correspond with the cursor location 342 in FIG. 3F. In step 444, a first set of text is identified based on the location. The first set of text may correspond with one or more sentences within a particular distance of the location within a document being edited. In step 446, a query phrase is generated using the first set of text. In one example, the query phrase may correspond with the query phrase 321 in FIG. 3C. In step 448, a set of search results is identified using the query phrase. In step 450, the set of search results is ranked. In step 452, a prompt for summarizing the set of search results is determined based on the ranking of the set of search results. The prompt for summarizing the set of search results may correspond with the prompt 328 in FIG. 3C. In step 454, a summary for the set of search results is generated using the prompt. The summary may be generated by inputting the prompt and the set of search results to a generative AI model. In step 456, it is detected that the summary comprises a consistent answer for the first set of text. In step 458, the summary and an identification of the set of search results are displayed. In step 460, it is detected that the summary should be assigned as a canonical summary for the first set of text. In step 462, the summary is stored as the canonical summary for the first set of text.

FIG. 4C depicts a flowchart describing one embodiment of a process for generating a summary of search results for a given search query and storing the summary. In one embodiment, the process of FIG. 4C may be performed by a search and knowledge management system, such as the search and knowledge management system 120 in FIG. 1 or the search and knowledge management system 220 in FIG. 2A. In another embodiment, the process of FIG. 4C may be implemented using a cloud-based computing platform or cloud-based computing services.

In step 472, a search query is identified. In step 474, a set of search results is generated using the search query. In step 476, the set of search results is ranked. In step 478, it is detected that at least a threshold number of users have submitted the search query or a semantically similar search query. In step 480, it is detected that an answer summary for the search query should be generated using the ranked set of search results in response to detection that at least a threshold number of users have submitted the search query or a semantically similar search query. In one example, upon detection that at least two end users have both submitted a semantically similar search query within a past threshold period of time (e.g., within the past 24 hours), a search and knowledge management system may automatically detect that the answer summary for the search query should be generated and generate the answer summary using a generative AI model.

In step 482, a maximum latency for generating the answer summary is determined. The maximum latency for generating answer summary may depend upon how the search query was submitted. In one example, if the search query was submitted in a search bar, then the maximum latency for generating the answer summary may comprise at most one second; however, if the search query was implied based on end user edits within a word processing document, then the maximum latency for generating the answer summary may comprise at most ten seconds. In step 484, a maximum snippet size for the set of search results is determined based on the maximum latency. The maximum snippet size may be set such that the answer summary may be generated in less time than the maximum latency. In step 486, a subset of the set of search results is determined based on the maximum latency. The subset of the set of search results may be identified such that the answer summary may be generated in less time than the maximum latency. In step 488, the answer summary is generated using the subset of the set of search results and the maximum snippet size. In step 490, the answer summary is stored. The answer summary may be stored in a database, such as the database DB 215 in FIG. 2B.

At least one embodiment of the disclosed technology includes identifying a search query, generating a set of search results using the search query, detecting that an answer summary for the set of search results should be generated in response to detection that at least a threshold number of users have submitted a semantically similar search query to the search query, determining a maximum latency for generating the answer summary, determining a subset of the set of search results based on the maximum latency for generating the answer summary, generating the answer summary using the subset of the set of search results, and storing the answer summary using a non-volatile storage device.

At least one embodiment of the disclosed technology comprises a search system including a storage device (e.g., a semiconductor memory) and one or more processors in communication with the storage device. The storage device is configured to store a prompt (e.g., a text prompt). The one or more processors are configured to identify a search query, generate a set of search results using the search query, detect that an answer summary for the set of search results should be generated, determine a latency for generating the answer summary, identify a subset of the set of search results based on the latency for generating the answer summary, generate the answer summary using the subset of the set of search results and the prompt, and store the answer summary.

At least one embodiment of the disclosed technology comprises a search system including one or more processors configured to generate a set of search results for a search query, detect that an answer summary for the set of search results should be generated, determine an estimated amount of time to generate the answer summary, identify a subset of the set of search results based on the estimated amount of time to generate the answer summary, generate the answer summary using the subset of the set of search results, and display the answer summary.

The disclosed technology may be described in the context of computer-executable instructions being executed by a computer or processor. The computer-executable instructions may correspond with portions of computer program code, routines, programs, objects, software components, data structures, or other types of computer-related structures that may be used to perform processes using a computer. Computer program code used for implementing various operations or aspects of the disclosed technology may be developed using one or more programming languages, including an object oriented programming language such as Java or C++, a function programming language such as Lisp, a procedural programming language such as the “C” programming language or Visual Basic, or a dynamic programming language such as Python or JavaScript. In some cases, computer program code or machine-level instructions derived from the computer program code may execute entirely on an end user's computer, partly on an end user's computer, partly on an end user's computer and partly on a remote computer, or entirely on a remote computer or server.

The flowcharts and block diagrams in the figures provide illustrations of the architecture, functionality, and operation of possible implementations of systems, methods, and computer program products according to various aspects of the disclosed technology. In this regard, each step in a flowchart may correspond with a program module or portion of computer program code, which may comprise one or more computer-executable instructions for implementing the specified functionality. In some implementations, the functionality noted within a step may occur out of the order noted in the figures. For example, two steps shown in succession may in fact, be executed substantially concurrently, or the steps may sometimes be executed in the reverse order, depending upon the functionality involved. In some implementations, steps may be omitted and other steps added without departing from the spirit and scope of the present subject matter. In some implementations, the functionality noted within a step may be implemented using hardware, software, or a combination of hardware and software. As examples, the hardware may include microcontrollers, microprocessors, field programmable gate arrays (FPGAs), and electronic circuitry.

For purposes of this document, the term “processor” may refer to a real hardware processor or a virtual processor, unless expressly stated otherwise. A virtual machine may include one or more virtual hardware devices, such as a virtual processor and a virtual memory in communication with the virtual processor.

For purposes of this document, it should be noted that the dimensions of the various features depicted in the figures may not necessarily be drawn to scale.

For purposes of this document, reference in the specification to “an embodiment,” “one embodiment,” “some embodiments,” “another embodiment,” and other variations thereof may be used to describe various features, functions, or structures that are included in at least one or more embodiments and do not necessarily refer to the same embodiment unless the context clearly dictates otherwise.

For purposes of this document, a connection may be a direct connection or an indirect connection (e.g., via another part). In some cases, when an element is referred to as being connected or coupled to another element, the element may be directly connected to the other element or indirectly connected to the other element via intervening elements. When an element is referred to as being directly connected to another element, then there are no intervening elements between the element and the other element.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify or distinguish separate objects.

For purposes of this document, the term “set” of objects may refer to a “set” of one or more of the objects.

For purposes of this document, the phrases “a first object corresponds with a second object” and “a first object corresponds to a second object” may refer to the first object and the second object being equivalent, analogous, or related in character or function.

For purposes of this document, the term “or” should be interpreted in the conjunctive and the disjunctive. A list of items linked with the conjunction “or” should not be read as requiring mutual exclusivity among the items, but rather should be read as “and/or” unless expressly stated otherwise. The terms “at least one,” “one or more,” and “and/or,” as used herein, are open-ended expressions that are both conjunctive and disjunctive in operation. The phrase “A and/or B” covers embodiments having element A alone, element B alone, or elements A and B taken together. The phrase “at least one of A, B, and C” covers embodiments having element A alone, element B alone, element C alone, elements A and B together, elements A and C together, elements B and C together, or elements A, B, and C together. The indefinite articles “a” and “an,” as used herein, should typically be interpreted to mean “at least one” or “one or more,” unless expressly stated otherwise.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a storage device configured to store a prompt; and
one or more processors in communication with the storage device configured to:
identify a search query;
generate a set of search results using the search query;
detect that an answer summary for the set of search results should be generated;
determine a latency for generating the answer summary;
identify a subset of the set of search results based on the latency for generating the answer summary;
generate the answer summary using the subset of the set of search results and the prompt; and
store the answer summary.

2. The system of claim 1, wherein:
the one or more processors are configured to generate the answer summary using a generative artificial intelligence model, the prompt, and the subset of the set of search results.

3. The system of claim 2, wherein:
the generative artificial intelligence model comprises a generative pre-trained transformer model.

4. The system of claim 1, wherein:
the one or more processors are configured to detect that at least a threshold number of users have submitted a semantically similar search query to the search query and detect that the answer summary for the set of search results should be generated in response to detection that at least the threshold number of users have submitted the semantically similar search query to the search query.

5. The system of claim 1, wherein:
the one or more processors are configured to determine a location within a document and identify the search query based on the location within the document.

6. The system of claim 1, wherein:
the one or more processors are configured to determine a maximum snippet size for the set of search results based on the latency for generating the answer summary and determine the subset of the set of search results based on the maximum snippet size.

7. The system of claim 1, wherein:
the one or more processors are configured to cause the answer summary to be displayed.

8. The system of claim 1, wherein:
the one or more processors are configured to input the subset of the set of search results and a text directive to generate the answer summary to a generative artificial intelligence model.

9. The system of claim 1, wherein:
the one or more processors are configured to input the subset of the set of search results and a text directive to reference one or more search results that were used to generate the answer summary to a generative artificial intelligence model.

10. The system of claim 1, wherein:
each of the set of search results comprises an electronic document that was verified by a document owner.

11. The system of claim 1, wherein:
the one or more processors are configured to determine an estimated latency for generating the answer summary and determine a number of search results comprising the subset of the set of search results based on the estimated latency.

12. The system of claim 1, wherein:
the one or more processors are configured to determine an amount of time to generate the answer summary and determine a number of search results comprising the subset of the set of search results based on the amount of time to generate the answer summary.

13. The system of claim 1, wherein:
the one or more processors are configured to determine an amount of time to generate the answer summary and determine a total amount of text for the subset of the set of search results based on the amount of time to generate the answer summary.

14. The system of claim 1, wherein:
the one or more processors are configured to detect that an amount of time to generate the answer summary is greater than a threshold amount of time and generate the answer summary in the background while the subset of the set of search results is displayed.

15. The system of claim 1, wherein:
the one or more processors are configured to detect that an amount of time to generate the answer summary using a generative artificial intelligence model is greater than a threshold amount of time and generate the answer summary while the subset of the set of search results is displayed.

16. The system of claim 1, wherein:
the one or more processors are configured to detect a triggering condition and perform a search for the search query using user permissions based on a number of end users that submitted search queries that are semantically similar to the search query.

17. The system of claim 1, wherein:
the one or more processors are configured to generate the answer summary using a first set of documents and generate a second answer summary in the background using a second set of documents that is larger than the first set of documents.

18. A method for operating a search system, comprising:
identifying a search query;
generating a set of search results using the search query;
detecting that an answer summary for the set of search results should be generated in response to detection that at least a threshold number of users have submitted a semantically similar search query to the search query;
determining a maximum latency for generating the answer summary;
determining a subset of the set of search results based on the maximum latency for generating the answer summary;
generating the answer summary using the subset of the set of search results; and
storing the answer summary using a non-volatile storage device.

19. The method of claim 18, wherein:
the generating the answer summary includes generating the answer summary by inputting the subset of the set of search results to a generative pre-trained transformer model.

20. One or more storage devices containing processor readable code for configuring one or more processors to perform a method for operating a search system, wherein the processor readable code configures the one or more processors to:
generate a set of search results for a search query;
detect that an answer summary for the set of search results should be generated;
determine an estimated amount of time to generate the answer summary;
identify a subset of the set of search results based on the estimated amount of time to generate the answer summary;
generate the answer summary using the subset of the set of search results; and
display the answer summary.
